(19) United States
(12) Patent Application Publication
(10) Pub. No.: US 2024/0232742 A9
(43) Pub. Date: Jul. 11, 2024

(54) DRIVER TRAINING METHOD

(71) Applicants: Krishna Parajuli, Scarborough (CA); Tank Doranga, Scarborough (CA)

(72) Inventors: Krishna Parajuli, Scarborough (CA); Tank Doranga, Scarborough (CA)

(21) Appl. No.: 18/048,106

(22) Filed: Oct. 20, 2022

(51) Int. Cl. G06Q 10/10; G06Q 10/06; G06Q 20/10

(52) U.S. Cl. CPC G06Q 10/1093; G06Q 10/063112; G06Q 10/06398; G06Q 20/102

(57) ABSTRACT

A driver education method that utilizes a software application that facilitates the connection of a driving student and a driving instructor wherein the software application provides features such as but not limited to scheduling and driving instructor selection. The method of the present invention allows students to select driving instructors based on a plurality of parameters that include but are not limited to geographical proximity, language and rankings. The present invention further provides a scheduling function wherein the availability of the driving instructors selected by the student are provided to the student and the student can make a selection therefrom. The driver education method of the present invention includes training in a plurality of formats that include but are not limited to in-vehicle training, remote learning and video lessons. The present invention further facilitates payment between the student and the driving instructor.

### FIELD OF THE INVENTION

The present invention relates generally to facilitation of driver education, more specifically but not by way of limitation, a driver education software application for use by instructors and students wherein an instructor can be identified by prospective students and wherein students can select from a plurality of driving instructors to book driving lessons.

### BACKGROUND

In most countries the predominant method of transportation is the automobile. The automobile has been around for over one hundred years and its first models were the output of the beginnings of the industrial revolution. All countries require a license to drive an automobile and these countries also have a minimum age limit that must be met in order to obtain a license to drive an automobile, in order to obtain a license to drive an automobile in most countries an individual must pass a written test as well as a driving exam. For the written test, most individuals utilize a study guide, a preparation class or a combination thereof as a technique to prepare for the written exam.

In regards to the driving exam required to obtain a drivers license, many individuals will take driving lessons from a qualified driving instructor. These driving lessons are often arranged through driving schools wherein the driving school has on staff a plurality of driving instructors and the students are assigned a driving instructor that will provide the driving lesson. There are several issues that are associated with the conventional system of obtaining driving classes from a driving school. One issue is that the students are limited to the schedule of the driving school and the availability of the driving instructors. While this may work for some students, many individuals requiring driving lessons have other obligations and are limited as to the times and days that they are available to take a driving lesson. Another issue is that most driving schools do not let students select their driving instructor. Different individuals respond to alternate teaching styles and as such may have a preference for a particular instructor. An ability to select a particular instructor is not provided by conventional driving schools.

Accordingly, there is a need for a driver education software application that facilitates the connection of a driving student and a driving instructor wherein the software application provides features such as but not limited to scheduling and driving instructor selection.

### SUMMARY OF THE INVENTION

It is the object of the present invention to provide a driver education software application that facilitates communication between a student and a plurality of driving instructors wherein the present invention facilitates scheduling of a day and time of a driving lesson.

Another object of the present invention is to provide a method of connecting a driving instructor with a plurality of students so as to deliver a driving lesson wherein the present invention provides remote learning to the student such as but not limited to video lessons.

A further object of the present invention is to provide a driver education software application that facilitates communication between a student and a plurality of driving instructors wherein the present invention further allows a student to select a driving instructor that will conduct lessons in a preferred language.

Still another object of the present invention is to provide a method of connecting a driving instructor with a plurality of students so as to deliver a driving lesson wherein the present invention provides a progress report to the student during the driving lesson sequence.

An additional object of the present invention is to provide a driver education software application that facilitates communication between a student and a plurality of driving instructors that further provides the ability for the student and the driving instructor to rate each other's performance and abilities.

Yet a further object of the present invention is to provide a method of connecting a driving instructor with a plurality of students so as to deliver a driving lesson that further provides to students the geographical location of driving instructors proximate to their location.

Another object of the present invention is to provide a driver education software application that facilitates communication between a student and a plurality of driving instructors wherein the present invention facilitates an ability for a driving instructor to independently work directly with students.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagram of the method of the present invention from the driving instructor perspective; and

FIG. 2 is a diagram of the method of the present invention from the student perspective.

### DETAILED DESCRIPTION

Referring now to the drawings submitted herewith, wherein various elements depicted therein are not necessarily drawn to scale and wherein through the views and figures like elements are referenced with identical reference numerals, there is illustrated a driver training method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

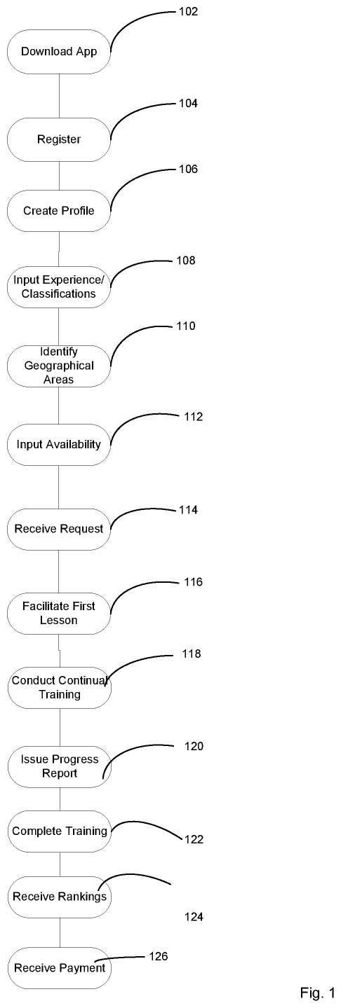

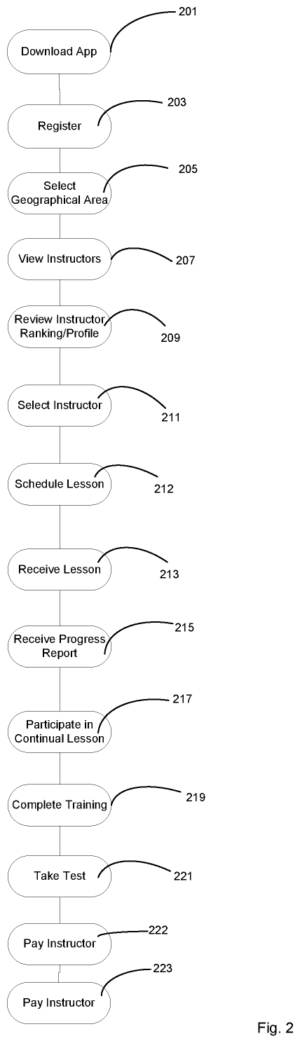

Referring in particular to Figures submitted as a part hereof, the driver training method 100 has the workflow and outputs thereof diagrammed in FIGS. 1 and 2. While the preferred embodiment of the present invention is focused in the field of driving instruction, it is contemplated within the scope of the present invention that the present invention could be applied to numerous alternate fields.

Referring now in particular to FIG. 1 herein, an exemplary process flow of the driver training method 100 for the driving instructor is diagrammed therein. In step 102, the driving instructor will download the software application of the present invention that facilitates the method of the present invention onto a suitable computing device such as but not limited to a smartphone or a portable computer. Step 104, the driving instructor will register with the software application inputting the requested information. In step 106, the driving instructor will create a profile which includes inputting information such as but not limited to name, photograph and fluent languages spoken. Step 108, the driving instructor will be prompted to input their experience, instructor license information and other parameters such as but not limited to what classifications of instruction the instructor can provide to include but not be limited to commercial classifications. In step 110, the instructor will identify the geographical areas in which they are available to students to perform driver training. It should be understood within the scope of the present invention that the initially selected geographical area is not static and can be updated and changed by the driving instructor at any time.

Step 112, the driving instructor will utilize the availability calendar of the software of the present invention to input the availability for teaching of driving lessons in the identified geographical areas. In step 114, the driving instructor will receive a request from a student for a driving lesson. In step 116, the driving instructor will facilitate delivery of the first driving lesson. It should be understood within the scope of the present invention that the first driving lesson or any subsequent driving lesson could be a written lesson, a video lesson or an in-vehicle lesson. Step 118, the driving instructor will conduct continual training lessons with the student in any of the aforementioned formats. In step 120, the driving instructor will issue a progress report utilizing the software application of the present invention wherein the progress report will be transmitted to the student. It should be understood within the scope of the present invention that the driving instructor could issue more than one progress report and provide issuance thereof at any time during the training engagement with the student.

Step 122, the driving instructor will complete the training schedule of the student either in compliance with any governing regulations or through professional evaluation. In step 124, the driving instructor will receive a ranking from the student as to the quality of the instruction that was provided by the driving instructor. It should be understood within the scope of the present invention that the ranking could be a numerical scale or utilize symbols such as but not limited to stars. In step 126, the driving instructor will receive payment from the student for delivery of the driving lessons via the software application of the present invention. It should be understood within the scope of the present invention that the driving instructor could receive payments in various schedules and at various times while conducting the driver training curriculum.

Now referring to FIG. 2 submitted as a part hereof, an exemplary process flow of the driver training method 100 for the student is diagrammed therein. In step 201, the student will download the software application of the present invention onto a suitable computing device such as but not limited to a smartphone. Step 203, the student will be prompted to register with the software application wherein the student will be prompted to enter data parameters regarding themselves such as but not limited to name, address and payment information. In step 205, the student will select a desired geographical area proximate to their location in which the student would like to identify a driving instructor. Step 207, ensuing entering the desired geographical area, the student will be presented with the available driving instructors for that area. In step 209, the student will review the rankings and profile information of the identified instructors. Step 211, the student will select an instructor from the provided list available in the desired geographic area. In step 212, the student will schedule a lesson with the selected instructor utilizing the calendar feature within the software application of the present invention that the identifies the days and times that the selected driving instructor is available.

Step 213, the student will receive the initial driving lesson from the selected driving instructor. As mentioned above herein the driving lesson can be comprised of several different formats to include remote learning, video or in-vehicle lessons. In step 215, either subsequent each driving lesson or after a group of lesson the student will receive a progress report from the driving instructor. Step 217, the student will participate in continual lessons in a quantity as either dictated by the instructor or the student themselves. In step 219, the student will complete the training curriculum ensuing participation in all of the driving lessons. Step 221, if applicable the student will take a driving test administered by the driving instructor. It should be understood that this step may vary due to local regulations. In step 223, ensuing the completion of the driving lessons or during the participation therein, the student will transmit payment to the driving instructor utilizing the payment feature within the software application of the present invention. Step 225, ensuing completion of participation in the driving lessons the student will provide a ranking of their experience with the driving instructor utilizing the aforementioned ranking system applicable to students.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A driver education method that utilizes a software application to facilitate a connection of a driving student and a driving instructor wherein the driver education method comprises:
downloading the software application, wherein the driving instructor and the student download the software application to remote computing devices;
registering with the software application wherein the student enters registration information into the software application and wherein the driving instructor registers with the software application;
creating a profile, wherein the driving instructor creates a profile, wherein the profile compiles information about the driving instructor,
identifying a geographical area, wherein the driving instructor will identify a geographical area in which the driving instructor is available to provide in-vehicle driving lessons;
inputting an availability, wherein the driving instructor will utilize a calendar feature of the software application to input available days and times for which the driving instructor can provide driving lessons;
selecting a geographical area, wherein the student will utilize the software application to select a geographical area in which the student desires to receive driving lessons;
reviewing a list of driving instructors, wherein the student reviews a list of driving instructors available in the selected geographical area;
scheduling a driving lesson, wherein the student utilizes the calendar feature to select a day and time to receive a driving lesson;
receiving a driving lesson request, wherein the driving instructor receives a notification from the software application that a student has scheduled a driving lesson;
delivering the driving lesson, wherein the driving instructor delivers the driving lesson to the student; and
completing the driving lesson, wherein the student completes the driving lesson delivered by the driving instructor.

2. The driver education method that utilizes the software application to facilitate a connection of the driving student and the driving instructor as recited in claim 1, and further including the step of generating a progress report, said progress report being generated by the driving instructor and deliver to the student subsequent execution of the driving lesson.

3. The driver education method that utilizes the software application to facilitate a connection of the driving student and the driving instructor as recited in claim 2, and further including the step of participating in an additional driving lesson, wherein the student engages in at least one additional driving lesson from the driving instructor.

4. The driver education method that utilizes the software application to facilitate a connection of the driving student and the driving instructor as recited in claim 3, wherein the driving lesson is provided in a format selected from one of the following: an in-vehicle lesson, a remote lesson or a video lesson.

5. The driver education method that utilizes the software application to facilitate a connection of the driving student and the driving instructor as recited in claim 4, wherein the profile includes collection of a parameter regarding fluent languages spoken by the instructor.

6. The driver education method that utilizes the software application to facilitate a connection of the driving student and the driving instructor as recited in claim 5, and further including a step of providing a confirmation for a request for a driving lesson.

7. The driver education method that utilizes the software application to facilitate a connection of the driving student and the driving instructor as recited in claim 6, and further including a step of selecting a geographic location for delivery of the driving lesson.

8. The driver education method that utilizes the software application to facilitate a connection of the driving student and the driving instructor as recited in claim 7, and further including the step of transmitting a payment to the driving instructor, wherein the payment is transmitted subsequent the driving lesson.

9. The driver education method that utilizes the software application to facilitate a connection of the driving student and the driving instructor as recited in claim 8, and further including the step of updating the geographical area, wherein the driving instructor updates the geographical area for availability for providing driving lessons.

10. The driver education method that utilizes the software application to facilitate a connection of the driving student and the driving instructor as recited in claim 9, and further including the step of ranking the driving instructor, wherein the student utilizes the software application to rank the driving instructor.
